(19) United States
(12) Patent Application Publication
(10) Pub. No.: US 2014/0129934 A1
(43) Pub. Date: May 8, 2014

(54) DYNAMIC MODEL-BASED MANAGEMENT TOOLING

(71) Applicant: MICROSOFT CORPORATION, Redmond, WA (US)

(72) Inventors: Jason Hogg, Kirkland, WA (US); Joshy Joseph, Redmond, WA (US)

(73) Assignee: MICROSOFT CORPORATION, Redmond, WA (US)

(21) Appl. No.: 13/672,582

(22) Filed: Nov. 8, 2012

(51) Int. Cl. G06F 3/01

(52) U.S. Cl. CPC G06F 3/01
USPC 715/708

(57) ABSTRACT

The subject disclosure is directed towards a technology by which a management tool locates, processes and runs guidance package, comprising program code and associated metadata. The management tool may be associated with an interactive component configured to obtain user-related data. The management tool accesses one or more guidance packages based upon the user-related data, processes the metadata of at least one guidance package, and runs program code of at least one guidance package based upon the metadata.

### BACKGROUND

Designers of graphical user interface (GUI)-based management tools seek to provide the right combination of management use cases so that the tools support the majority of their users' needs. This leads to a dilemma as to how complex to design a tool. If too few use cases are supported, then the tooling will not meet the needs of the majority of their users, which impacts the uptake of the product. If too many use cases are supported, then the tooling tends to be overly complex, affecting the users' ability to learn the product and making it difficult for an organization to ensure consistency across a number of users.

To mitigate this problem, management tools such as the MMC (Microsoft® Management Console) have an extensibility model that enables new “plug-ins” to be defined. However, designers these plug-ins basically have the same challenge, that is, if they address too many use cases they become overly complex, if they address too few they do not meet a broad audiences needs. From an end user's perspective, there is only a limited ability to customize the experience to meet the user's needs—typically at the granularity of the snap-in—which is fairly course grained. There is also limited ability to define customize the layout of the UI by role/permissions, and the like.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a guidance package, comprising program code and associated metadata, is located based upon user-related data. The metadata is processed, with the program code of the guidance package activated based upon at least some of the user-related data and at least some of the metadata.

A guidance package may be run via a management tool, which is associated with an interactive component configured to obtain user-related data. The management tool accesses one or more guidance packages based upon the user-related data, processes the metadata of at least one guidance package, and runs program code of at least one guidance package based upon the metadata.

In one aspect, there is described running a first guidance package comprising first program code and associated first metadata, and running a second guidance package comprising second program code and associated second metadata. Processing the first metadata and/or the second metadata determines a relationship between the first guidance package and the second guidance package.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram including components configured to generate a model from an input program, which is used for rendering a wizard and obtaining program code, according to one example embodiment.

FIG. 2 is a block diagram representing the packaging, storing and distributing of a guidance package, according to one example embodiment.

FIG. 3 is a flow diagram representing a management tool that process and runs guidance packages, according to one example embodiment.

FIG. 4 is a flow diagram representing example steps that may be taken to process and run guidance packages, according to one example embodiment.

FIG. 5 is a block diagram representing an example computing environment, into which aspects of the subject matter described herein may be incorporated.

### DETAILED DESCRIPTION

Various aspects of the technology described herein are generally directed towards processing “guidance packages” comprising defined product management extensions at an atomic level of detail. Note that a guidance package may appear to a user as a wizard as one straightforward example, however as will be understood, guidance package (extensions) may be significantly more complex than a wizard, e.g., any UI control or set of controls that solicits input and performs behavior. In this way, the tooling is able to remove the typical constraints (e.g., hard coded wizards with no insight into execution logic) that typically accompany management tools such as the MMC.

With respect to processing guidance packages, guidance packages may be composed and loaded dynamically inside a management tool. The management tool (e.g., the shell) locates the guidance packages from an appropriate source location, such as local storage, an intranet repository, from the original guidance packages authors publishing location, from the cloud and/or the like. The management tool may determine if updated versions of guidance packages exist, and may prompt the user to update if appropriate. The management tool also may arrange the guidance packages as appropriate for the particular user's needs, and compose multiple packages to support multiple use cases into a cohesive set, depending on the usage context. Still further, the management tool may enable or disable the guidance packages based on constraints such as permissions or lack of context, as well as activate guidance packages as context/permissions are granted.

In one implementation, the configuration of the management tool is specified in a configuration file. These configurations may be nested, thus allowing groups of guidance packages for a particular domain to be packaged together (e.g., to provide a collection of capabilities similar to those provided inside a Snap-In).

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computers and management tooling in general.

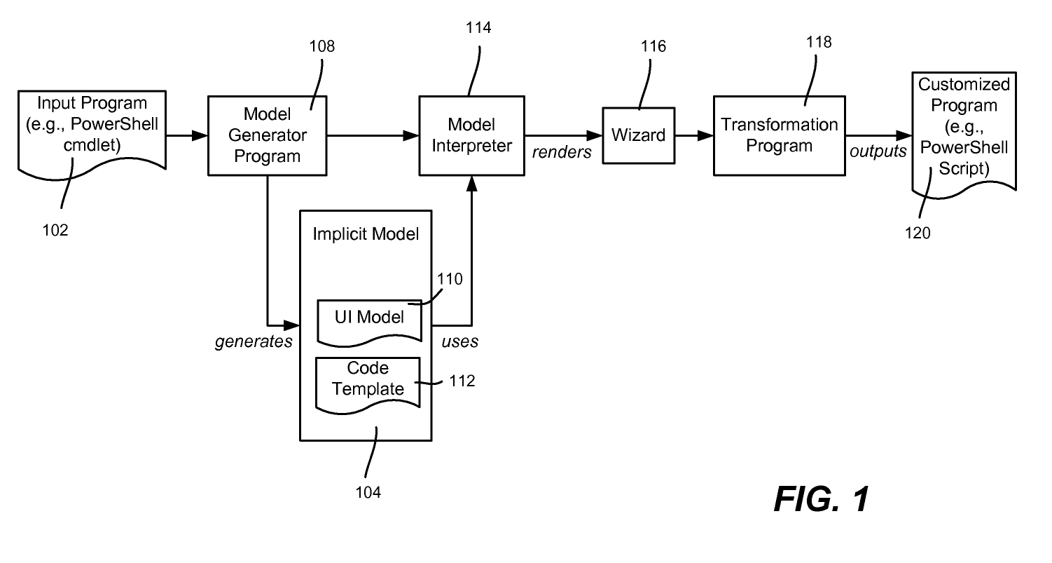

FIG. 1 shows a block diagram comprising an example implementation in of a three-stage process for taking an input program 102 (e.g., a Windows® Powershell® cmdlet) and generating a model 104 (implicit model), which is then used as the basis for rendering a wizard 106, for example. The model 104 may be discarded (not persisted), or instead persisted so as to allow a user to modify the UI, the validation logic and/or the code template used for generating code. Note that the UI model may be hard coded, or automatically inferred, e.g., from the cmdlet. Automatically inferred models may be edited, e.g., for customization.

In this example, the user executes a model generator program 108 which takes as an input program 102 (e.g., the Windows® Powershell® cmdlet) for which a UI is to be generated. The program 108 may reflect on the signature of the cmdlet function, the number of parameters, the types of these parameters and whether they are optional or mandatory. This information is then used by the model generator program 108 to generate a default UI model 110 (e.g., a XAML based form, such as defining a set of pages in text files and how they interact with each other, e.g., an introduction page, interaction page and error-handling page) and appropriate input validation logic. The information is also used to generate a default code template 112.

Note that in extensible scenarios, the program 108 presents the generated model to the user to decide on single cmdlet versus a pipeline or a workflow. This user input allows for composing complex application execution scenarios. Additionally, experts can customize and provide default parameters and flow conditions/rules as desired.

A model interpreter 114 may take the generated model 104 (comprising the UI model 110 and template 112) and execute the model 104, providing a wizard 116 (e.g., a single page) or the like to an end-user within which to enter input parameters. Users may extend this model to include guidance topics, examples and links to knowledge articles, for example.

After the user completes the wizard 116, a transformation program 118 takes the input parameters and inserts them into the code template 112 via transformation. This results in a customized program 120 (e.g., a Windows® Powershell® script or a pipeline of Windows® Powershell® scripts that are executable by the Windows® Powershell® interpreter). Each script can be shown to the user prior to execution or executed transparently. The artifacts generated by these processes such as UI Wizards, associated models and context may be collectively referred to herein as guidance packages.

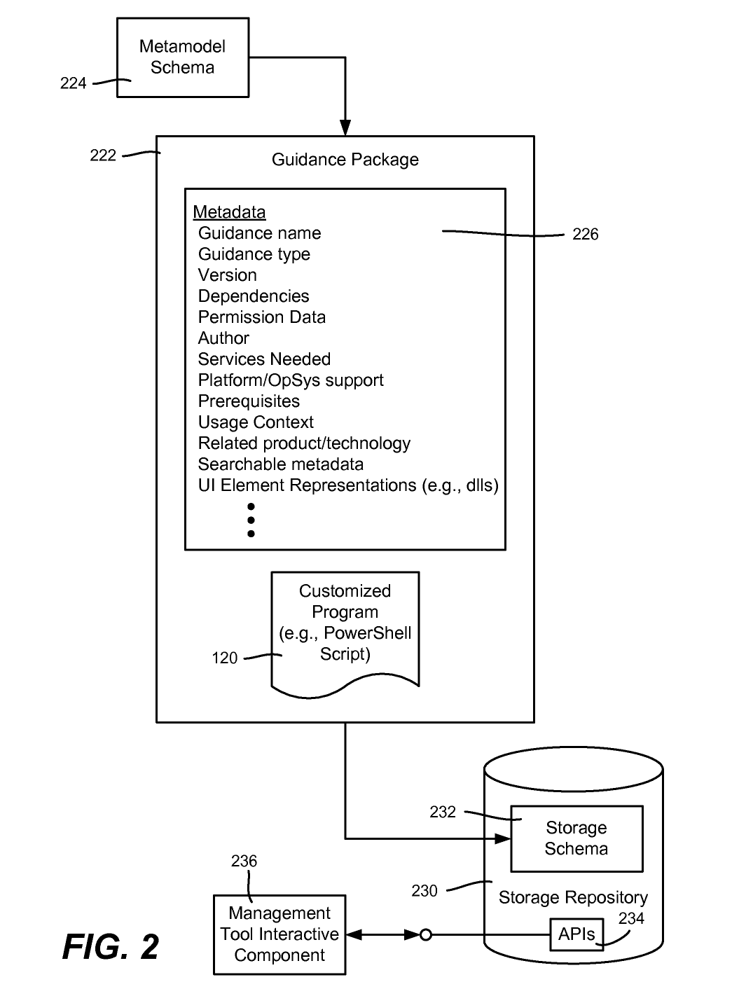

FIG. 2 represents a packaging model for guidance packages (guidance assets), e.g., including identifying the executable wizards, task usage context, narrative guidance, and other asset dependency maps. FIG. 2 also represents a storage model for guidance packages, and distribution aspects of guidance packages as also described in copending U.S. patent application entitled “PACKAGING, STORING AND DISTRIBUTING GUIDANCE PACKAGES”, attorney docket no. 335261.01.

With respect to packaging, a set of models define a guidance package 222 at an atomic level. These models, e.g., implemented as a set of methods, packages the specific guidance assets into the guidance package 222, provides for searchable metadata regarding the package guidance, handles package interdependency, versioning, enumerates the user scenarios/tasks and applicable context. Another model provides a set of methods or the like that compose multiple atomic packages into a cohesive set. Another model may be used to compress and/or store assets in interdependent packages for straightforward synchronization.

In one implementation, a metamodel schema 224 (e.g., an XML schema) defines the guidance package asset model. The metamodel schema 224 defines a set of base elements, exemplified in FIG. 2 in the metadata 226 of the guidance package (e.g., a manifest file contained within a .zip file). Note that the example metadata 226 is not intended to be in any particular order in FIG. 2, and additional metadata elements may be included, and those exemplified in FIG. 2 need not all be present. In general, the exemplified metadata 226 includes information as to guidance name, guidance type, version, dependencies, permission data, author, services needed, platform/operating system support, prerequisites, usage context, related product/technology, searchable metadata, and the like. Note that permission-related data may be additionally or alternatively enforced by the operating system, e.g., via ACLs, tokens roles, and so forth. Filtering and/or ranking may be used, e.g., a database manager searching for packages may not see the same packages that a website author sees even with the same search criteria; a user may not see packages that he or she does not have sufficient permission to execute.

Also shown is an instantiation of this schema for Wizards based guidance package UI. Attributes of this Wizard package include representations (e.g., dlls) representing the UI elements, a map that identifies product scenarios/use cases and usage context. Each such package thus may contain versioning information and additional metadata such as author, services needed, platform/operating system support, pre-requisites, and reference to any dependent packages within and/or outside the package.

It should be noted that FIG. 2 is only one example implementation of a guidance package, in which the metadata is packaged with a customized program (e.g., packaged together in a .zip file so that they travel together). More generally, a guidance package comprises any association between the program and its metadata. Thus, for example, the program (e.g., an identifier thereof) may be used as a key to a database record containing the metadata for that program. A program may include a reference to a separate file that contains its associated metadata, e.g., by filename or by a pointer therein. Other ways of associating a program with its metadata are feasible.

With respect to storage of guidance packages in a local and/or online storage repository 230, guidance packages may be stored in any appropriate source location, e.g., locally on a user's computer, and/on an intranet or internet repository or a cloud location, such as at the original author's publishing location. A taxonomy may be associated with the storage to facilitate discovery of guidance packages.

In one implementation, a storage schema 232 is built following the guidance package metamodel. The storage schema 232 may expose additional metadata to help searching. Also the storage schema 232 may allow the storage to extract atomic package level metadata for efficient searching. The storage also may include logic/schema to handle package storage conflicts using the metadata, as well as enable version verification.

The exemplified storage repository 230 of FIG. 2 provides a set of APIs 234 to expose (e.g., including by example and not limitation to create, read, update, delete, and search) the guidance packages in the storage repository 230. In this way, the storage repository 230 provides a way for a program component (e.g., a management tool interactive component) to manage the packages and distribution, including synchronization with management tools in local computers.

Note that more than one type of repository may be available. For example, a staging repository may hold guidance packages for editing, testing and so forth before publishing to a publication repository.

Turning to the distribution of guidance packages, via the API set 234, users may access the storage repository 230 to locate a package and copy/download the package, may execute search commands to locate the packages, and may organize guidance packages as appropriate for the particular user's needs. Note that guidance packages (and possibly access thereto) may be enabled or disabled based on constraints such as permissions or lack of context. Guidance packages may be synchronized via change sets, with changed assets distributed to enable efficient data transfers.

In this way, guidance packages (product management extensions) will, over time, be defined consistently and at an atomic level of detail. The technology thus allows developing management shells separate from the atomic guidance tasks that will be developed, packaged, stored, and distributed separately. This helps build an extensible ecosystem of scenario-focused management tasks and provides consistency on discovery and integration with future management applications.

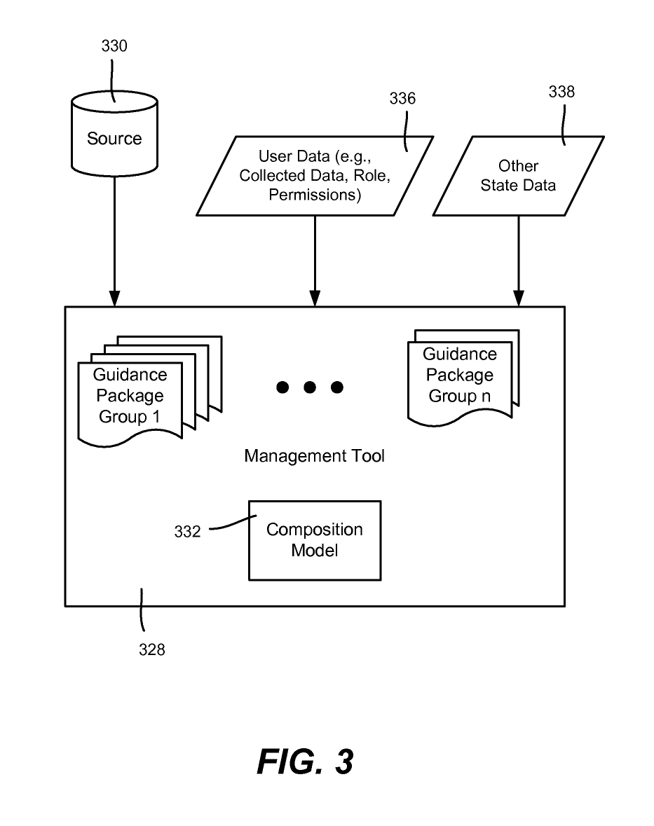

With respect to processing guidance packages to personalize the tooling experience, guidance packages may be composed and loaded dynamically inside a management tool 328 of FIG. 3, also referred to as the shell. The management tool 328 may include (or otherwise be associated with) the interactive component 236 (FIG. 2) that obtains the user data 336, (which may further represent user role, permissions and the like). Via the user data, the management tool 328 locates the guidance packages from an appropriate source location 330, which as described above may be local storage, an intranet repository, from the original guidance packages authors' publishing location, from the cloud and/or the like.

The management tool 328 may determine if updated versions of guidance packages exist, and may prompt the user to update if appropriate. The management tool 328 also may arrange the guidance packages as appropriate for the particular user's needs, and compose multiple packages to support multiple use cases into a cohesive set, depending on the usage context. Still further, the management tool 328 may enable or disable the guidance packages based on constraints such as permissions or lack of context, as well as activate guidance packages as context/permissions are granted.

In one implementation, the configuration of the management tool 328 is specified in a configuration file. These configurations may be nested, thus allowing groups of guidance packages for a particular domain to be packaged together. e.g., to provide a collection of capabilities (similar to those provided inside a Snap-In).

In one implementation, the management tool 238 comprises a set of shared functionality (e.g., as services) and is driven by a UI composition model 332. The shared services perform functions such as locating guidance packages from an appropriate source, checking to see if these guidance packages have been updated recently and enabling/disabling guidance packages based on availability of security claims (e.g., to run package A, role is manager, to run B, role is employee) and/or other relevant context. Different UI elements may appear depending on role, permissions, state, context and so forth.

The UI composition model 332 is the model that describes the combinations of guidance packages (e.g., group 1 to group n) that are currently being managed by the management tool 328. The UI composition model enables grouping of guidance packages together, thus enabling sets of functionality related to a common domain to be organized together, and/or sets of guidance packages appropriate for a particular user role to be organized together. The user can also modify the composition model 332, thus enabling a customized user interface. Depending on the user context and current targeted scenarios, the composition model 332 may consume multiple guidance packages and aggregate tasks suitable for the use case.

The management tool may contain and/or track state. For example, consider that a package or other task specifies that three steps are needed, step 1 which needs to complete before step 2, which needs to complete before step 3. The management tool thus does not run step 2 until step 1 completes, and step 3 until step 2 completes. Exceptions also may be tracked. Further, the decision process system may result in retrieving additional guidance packages (e.g., on demand) needed to complete the task.

While the above was an example of a simple linear state machine, more complex logic may be contained. For example, execution may branch depending on other state data 338 (e.g., available resources, time of day, date), and/or based upon user data, e.g., take one branch for an administrator level user, another for a lower privileged user, and so forth.

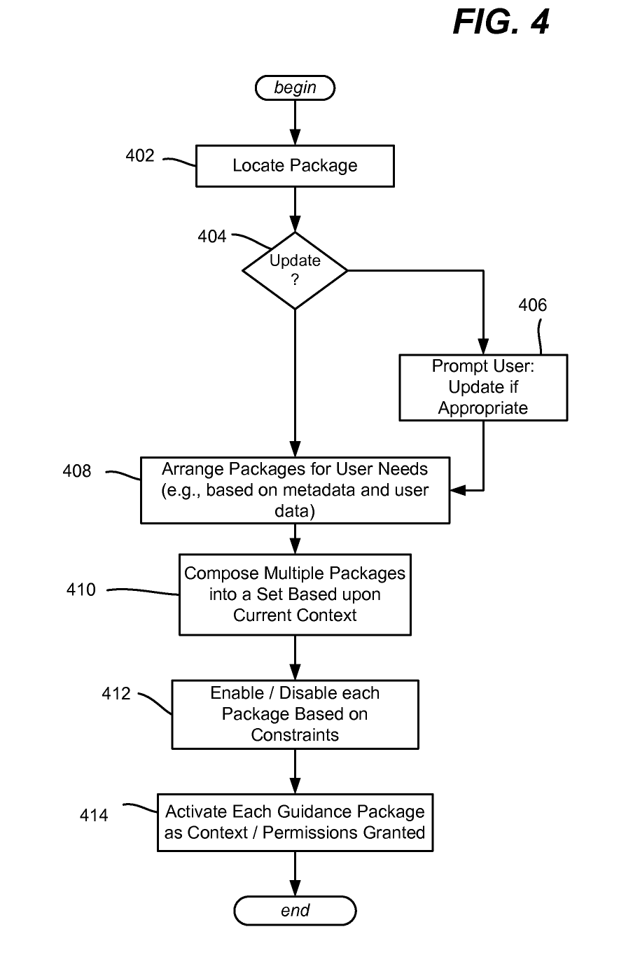

FIG. 4 is a flow diagram comprising example steps that summarize how a management tool may personalize the tooling experience and ensure that each guidance package inside the management tool is current. Step 402 represents locating the guidance packages from an appropriate source location or set of locations. Step 404 represents determining if updated versions of corresponding wizards exist, and prompting the user (step 406) to update if appropriate. Note that step 404 may operate for each package, (which may be at least in part a parallel operation), with any prompts/updating at step 406 combined as appropriate.

Step 408 represents arranging the guidance packages as appropriate for the particular user's needs. As described above, the various information including user needs and the like may be collected by the management tool interactive component 236 or the like as part of the overall process. Step 406 represents composing multiple packages to support multiple use cases into a cohesive set depending on a current context. For example, context information may be provided by the user, by other state data and so forth.

Step 410 is directed towards enabling the guidance packages or disabling them based on constraints such as permissions or lack of context. Note that interdependencies may be checked against permissions, roles and/or the like so that a user may not be able to use a package that depends upon completion of another package that has a higher level of permission and/or a different role than the user has. Step 412 represents activating guidance packages based upon context/as permissions are granted.

Another scenario allows users to customize the guidance package with additional metadata. The management tool may provide an option for users to customize the package metadata content for storage.

### Example Operating Environment

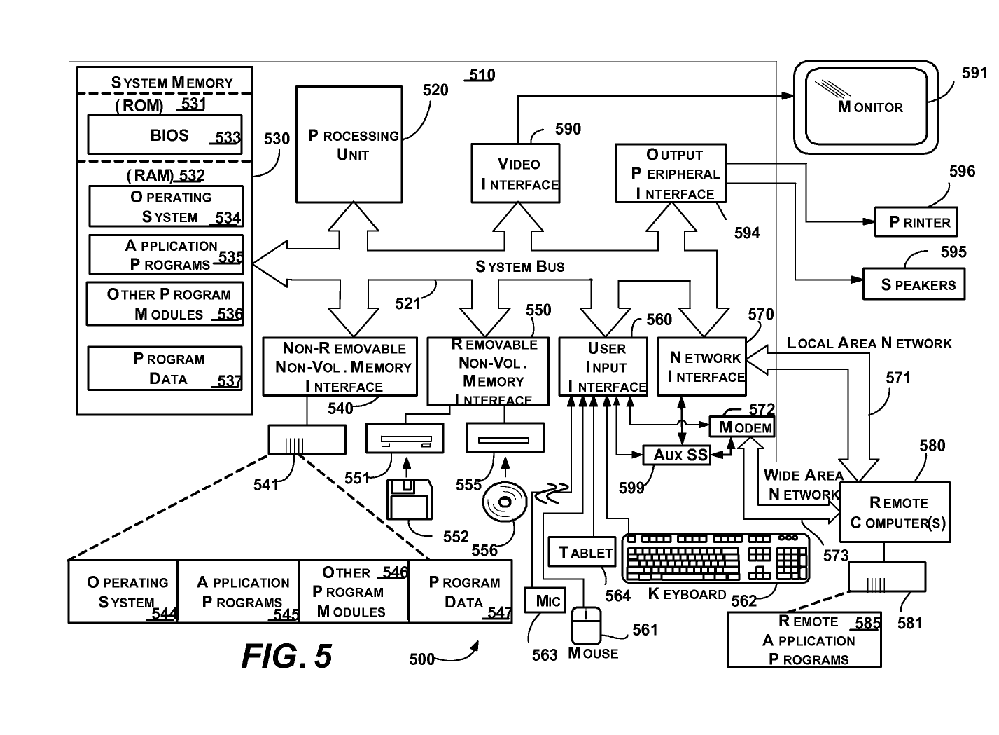

FIG. 5 illustrates an example of a suitable computing and networking environment 500 into which the examples and implementations of any of FIGS. 1-4 may be implemented, for example. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the example operating environment 500.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an example system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are examples and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

1. In a computing environment, a computer-implemented method comprising: locating a first model guidance package based upon user-related data within a management tool to create a customized management tool program, the first model guidance package comprising program code and associated metadata, processing the metadata, activating the program code of the first model guidance package, creating a second guidance package, wherein the second guidance package is based upon at least some of the user-related data and at least some of the metadata, and implementing the second guidance package to create the customized management tool program.

2. The computer-implemented method of claim 1 further comprising, determining if an updated version of a guidance package exists and if so, taking action to update the guidance package.

3. The computer-implemented method of claim 1 further comprising, collecting the user-related data, including collecting information related to one or more user needs, and further comprising arranging a plurality of guidance packages based upon the one or more user needs.

4. The computer-implemented method of claim 3 further comprising, composing the plurality of packages into a set.

5. The computer-implemented method of claim 3 further comprising, disabling at least one of the plurality of guidance packages based upon one or more constraints.

6. The computer-implemented method of claim 1 further comprising, enabling the guidance package based upon one or more constraints.

7. The computer-implemented method of claim 1 further comprising, tracking a completion status of the guidance package.

8. The computer-implemented method of claim 7 further comprising, activating another guidance package upon successful completion of execution of the guidance package.

9. The computer-implemented method of claim 1 wherein the metadata indicates that the guidance package has a dependency relationship with another guidance package.

10. The computer-implemented method of claim 1 wherein the metadata indicates that the guidance package is dependent upon completion of another guidance package, and wherein activating the guidance package comprises tracking a completion state of the other guidance package.

11. The computer-implemented method of claim 1 wherein the program code executes differently based upon the user-related data for one user compared to the user-related data of another user.

12. The computer-implemented method of claim 1 wherein the program code executes differently based upon state information.

13. The computer-implemented method of claim 1 wherein locating the guidance package comprises searching a repository of guidance packages based upon at least some of the user-related data.

14. A system comprising, a memory wherein the memory includes computer useable program code; and one or more processing units, wherein the one or more processing units executes the computer useable code to implement a management tool, the management tool associated with an interactive component configured to obtain user-related data, the management tool configured to access one or more guidance packages based upon the user-related data, process metadata of at least one guidance package, and run program code of at least one guidance package based upon the metadata.

15. The system of claim 14 wherein the management tool accesses the one or more guidance packages via at least one storage repository of guidance packages.

16. The system of claim 14 further comprising a composition model used by the management tool to arrange a plurality of guidance packages for execution.

17. The system of claim 14 wherein the management tool is further configured to determine if an updated version each guidance package exists, arrange a plurality of guidance packages based upon the user-related data, and compose the plurality of guidance packages into a set, and enable or disable any guidance package based on one or more constraints.

18. One or more computer storage devices having computer-executable instructions, which when executed perform steps, comprising, running a first guidance package comprising first program code and associated first metadata, and running a second guidance package comprising second program code and associated second metadata, including processing the first metadata and the second metadata, the first metadata or the second metadata, or both, indicating a relationship between the first guidance package and the second guidance package.

19. The one or more computer storage devices of claim 18 having further computer executable instructions comprising, tracking state data to determine that running the first guidance package has completed before running the second guidance package.

20. The one or more computer storage devices of claim 18 wherein processing the first metadata and the second metadata determines that the first guidance package and the second guidance package are part of a group.
